(19) United States
(12) Patent Application Publication
(10) Pub. No.: US 2026/0122503 A1
(43) Pub. Date: Apr. 30, 2026

(54) DEVICE PAIRING USING POWER-BASED COMMUNICATIONS

(71) Applicant: Dell Products L.P., Round Rock, TX (US)

(72) Inventors: CHRISTOPHER BAUER ATKINSON, Woodstock, GA (US); ETHAN A. KALEY, North Kingstown, RI (US); KIRK FREY, Flemington, NJ (US)

(21) Appl. No.: 18/931,508

(22) Filed: Oct. 30, 2024

(51) Int. Cl. H04W 12/50; H04L 67/55; H04W 12/06

(52) U.S. Cl. CPC H04W 12/50; H04L 67/55; H04W 12/068

(57) ABSTRACT

Methods and systems for managing a data processing system are disclosed. The data processing system (DPS) may identify that a power distribution unit (PDU) is operably connected via a multi-function connection adapted to both supply power to the DPS and facilitate communication between the DPS and the PDU. The DPS may identify a pairing state for the PDU that indicates whether the PDU is paired or unpaired. If the PDU is unpaired, a pairing process may be performed to attempt to change the pairing state for the PDU to paired. If the pairing state for the PDU is changed to paired, then a new power state for the DPS may be collaboratively enforced by the DPS with the PDU to obtain an updated DPS. The updated DPS may provide a computer-implemented service.

### FIELD

Embodiments disclosed herein relate generally to managing data processing systems. More particularly, embodiments disclosed herein relate to systems and methods for managing connections between the data processing systems.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1A shows a block diagram illustrating a distributed system in accordance with an embodiment.

FIG. 1B shows a block diagram illustrating a data processing system in accordance with an embodiment.

FIG. 1C shows a block diagram illustrating an example of a power distribution system in accordance with an embodiment.

FIGS. 2A-2B show interaction diagrams in accordance with an embodiment.

FIG. 3 shows a flow diagram illustrating a method in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing a data processing system. The data processing system may provide computer-implemented services to downstream consumers. To provide the computer-implemented services, the data processing system may obtain power from a power distribution system.

The power distribution system may convert large scale power input (e.g., from a utility power grid) to small scale power (e.g., usable by a data processing system), and may distribute the converted power to a deployment of data processing systems. The power distribution system may include multiple power distribution units (PDUs) and other components (e.g., power panels, transfer switches, back-up generators) that participate in distributing power to the deployment. At least a portion of the PDUs of the power distribution system may provide power to data processing systems via distinct power connections. For example, the PDUs may include rack PDUs that supply power to servers in a data center, or electrical wall outlets that provide power to personal devices (e.g., laptops, mobile phones, tablets) at a place of business (e.g., an airport, a coffee shop, an office building).

Power distribution within the deployment may be managed through power budgeting, wherein a power budget for the deployment defines limits on power supply to and/or consumption by components (e.g., data processing systems, PDUs) of the deployment over time. For example, the power budget may be determined based on a mapping of the power distribution system that indicates power connections between the components, power requirements and/or capacities of the components, ratings for the components, existing power caps for (e.g. limits regarding power consumption and/or supply by) the components, etc., as well as objectives for power distribution within the deployment (e.g., cost-saving objectives, production objectives).

For example, the power budget may be used to manage power caps for the components in order to meet the objectives for power distribution within the deployment. Therefore, if the mapping of the power distribution system is unreliable, then the power caps may be inadequate, and the objectives for power distribution within the deployment may be unlikely to be met. For example, power connections between the components may be established and/or re-established over time (e.g., as components are added, replaced, and/or removed, the power connections may be terminated and/or reconnected). However, if the power connections are not established and/or re-established as expected (e.g., consistent with the power connections defined in the mapping of the power distribution system), then the power caps may not be managed appropriately which may cause (i) inefficient distribution of power within the deployment, (ii) sudden increases in power consumption (e.g., power spikes that may lead to equipment damage), and/or (iii) other undesirable impacts to the power distribution system, operation of the data processing systems, and/or a quality of the computer-implemented service.

Thus, to increase reliability of the mapping of the power distribution system, unexpected power connections (e.g., erroneous power connections) established within the deployment may be identified and managed using device pairing. To do so, the data processing systems may be connected to the PDUs via distinct multi-function connections adapted to both supply power to the data processing system and facilitate communication between the data processing systems and the PDUs. For example, when a data processing system of the deployment identifies that an operable connection (e.g., power connection) is established with a PDU, data may be exchanged between the PDU and the data processing system using power-line communications over the multi-function connection. To facilitate the exchange of the data, initial power (e.g., a magnitude of power sufficient for performing a power onboarding process and insufficient for desired operation of the data processing system) is distributed via the multi-function connection.

For example, during a device pairing process for the data processing system and the PDU, credentials may be established between the devices to enable secure (e.g., cryptographically verifiable) communication, and, once established, sufficient power (e.g., a magnitude of power sufficient for desired operation of the data processing system) may be provided via the multi-function connection. If, after successful pairing of the devices the power connection is re-established, then a validation process may be performed to validate the device pairing before the sufficient power is provided to the data processing system via the PDU. If devices of the deployment are not successfully paired and/or not successfully validated, then power distribution to the data processing system may be limited (e.g., prevented), and an entity (e.g., management entity for the deployment) may be notified of an unexpected power connection.

By doing so, unexpected (e.g., erroneous) power connections within the deployment may be identified in real-time using existing multi-function connections and power-based communications. Management of the unexpected power connections may include, for example, generating notifications and/or physical alerts regarding the power connections (e.g., whether expected or unexpected), and/or enforcing power states for the data processing system that reflect outcomes of the device pairing and/or validation processes. As a result, the deployment may be more likely to provide desired (e.g., reliable, uninterrupted and/or otherwise expected) computer-implemented services without requiring additional types of connections between the data processing systems and the PDUs.

In an embodiment, a method for managing a data processing system is provided. The method may include: identifying, by the data processing system, that a power distribution unit (PDU) is operably connected via a multi-function connection, the multi-function connection being adapted to both supply power to the data processing system and facilitate communication between the data processing system and the PDU; and, identifying, by the data processing system, a pairing state for the PDU.

In a first instance of the identifying where the pairing state for the PDU is unpaired, the method may include: performing, by at least the data processing system, a pairing process to attempt to change the pairing state for the PDU to paired; and, in a first instance of the performing where the pairing state for the PDU is changed to paired, collaboratively enforcing, by the data processing system and with the PDU, a new power state for the data processing system to obtain an updated data processing system, and, providing, by the updated data processing system, a computer-implemented service.

Collaboratively enforcing the new power state for the data processing system may include obtaining, by the data processing system and from the PDU via the multi-function connection, information indicating the new power state for the data processing system. The information may be obtained using credentials established when the pairing state for the PDU is changed to paired. The credentials may enable communications between the data processing system and the PDU to be cryptographically verified.

The method may further include, in a second instance of the performing where the pairing state for the PDU is not changed to paired, entering, by the data processing system, a waiting state. While in the waiting state, the data processing system may attempt to connect to a second PDU until successful.

The method may further include, in a second instance of the identifying where the pairing state for the PDU is paired: collaboratively enforcing, by the data processing system and with the PDU, the new power state for the data processing system to obtain the updated data processing system; and, providing, by the updated data processing system, the computer-implemented service.

Collaboratively enforcing the new power state for the data processing system may include: providing, by the data processing system and via the multi-function connection, identification information usable to establish an identity of the data processing system to the PDU; and, obtaining, by the data processing system and via the multi-function connection, a response from the PDU, the response indicating characteristics of new power that the PDU believes is warranted for the data processing system.

The providing of the identification information and the obtaining of the response may be performed while power is being distributed via the multi-function connection.

Enforcing the new power state may modify power consumption by the data processing system.

The PDU may be adapted to obtain data center level power and supply power source level power via distinct multi-function connections to at least the processing system.

The data processing system may be connected to the PDU via an out-of-band communication channel that runs through a network module of the data processing system and the out-of-band communication channel may service a management controller of the data processing system.

The data processing system may be connected to at least one other entity via an in-band communication channel that also runs through the network module and the in-band communication channel may service hardware resources of the data processing system.

A non-transitory media may include computer instructions that when executed by a processor cause the computer-implemented method to be performed.

The data processing system may include the non-transitory media and a processor, and may perform the computer-implemented method when the computer instructions are executed by the processor.

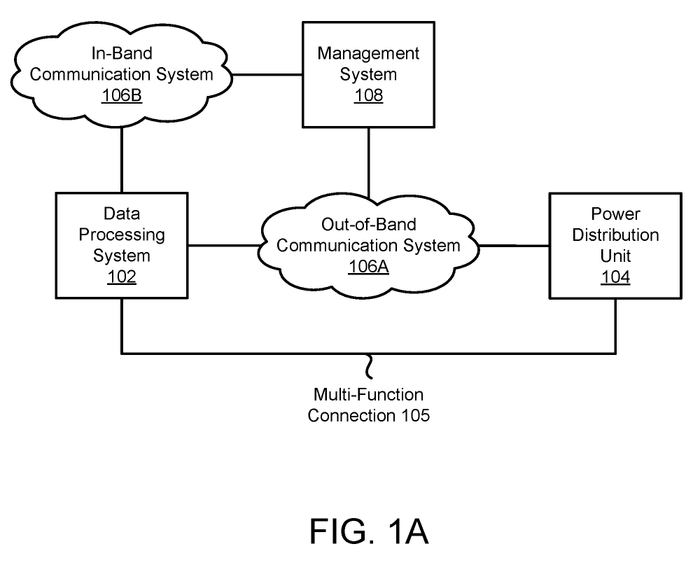

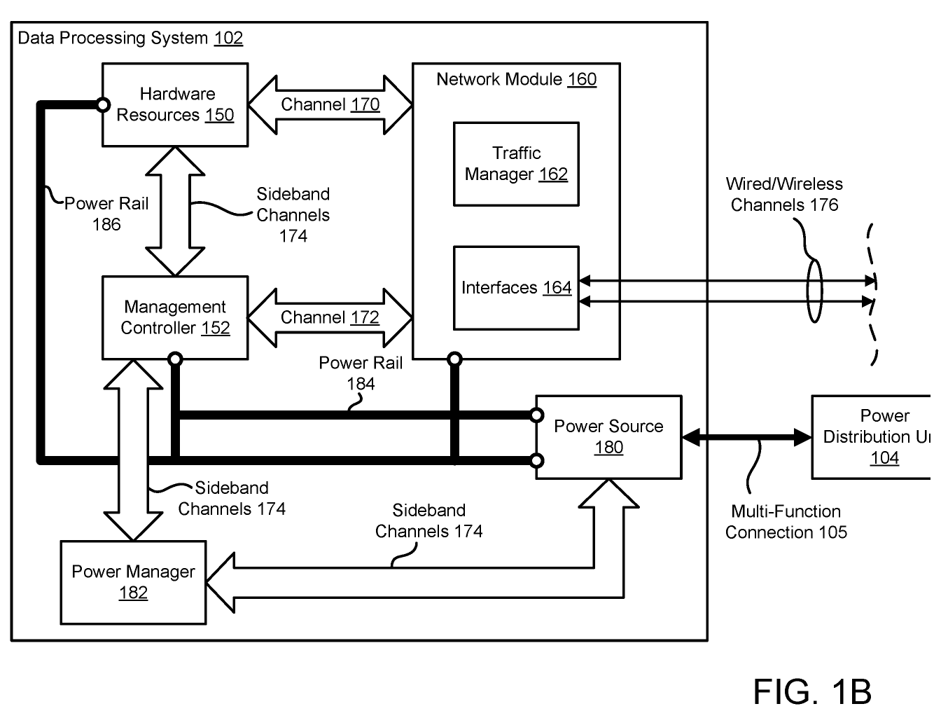

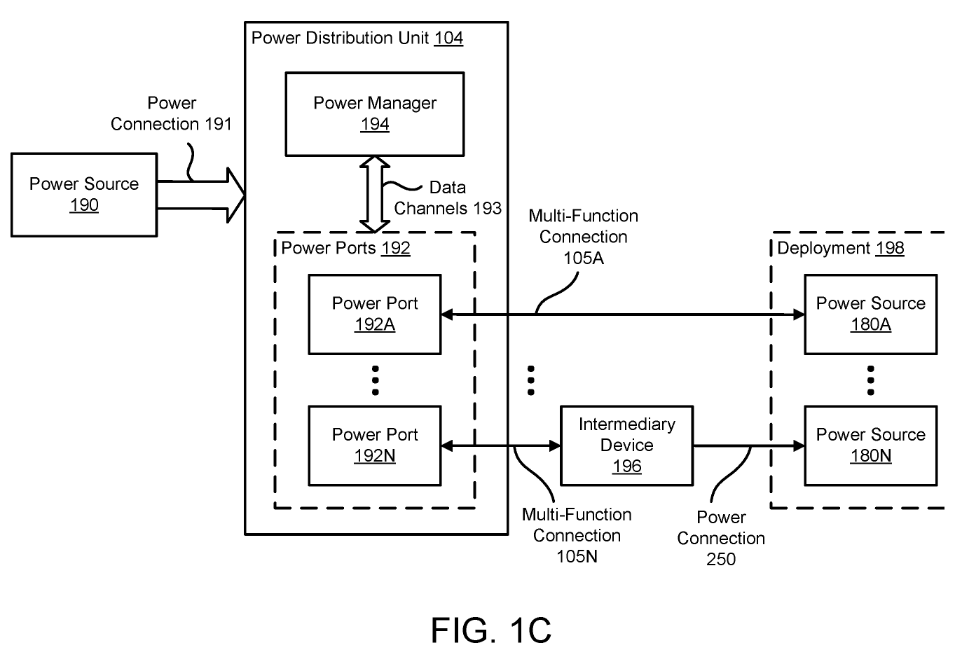

Turning to FIG. 1A, a block diagram illustrating a distributed system in accordance with an embodiment is shown. The system shown in FIG. 1A may provide computer-implemented services. The computer-implemented services may include any type and quantity of computer-implemented services. For example, the computer-implemented services may include communication services, data storage services, database services, data generation services, and/or any other type of service that may be implemented with a computing device.

To provide the computer-implemented services, the distributed system may include any number of data processing systems of a deployment. Each data processing system may include hardware resources (e.g., hardware and/or software components) and may independently and/or in some combination with the other data processing systems, provide a portion of the computer-implemented services. The data processing systems may each include a power source that provides power to the hardware resources, and each power source may obtain power through a power connection to a power distribution system of the deployment.

The power distribution system may include various components for obtaining large scale power such as data center level power, and supplying small scale power, such as power source level power usable by the power sources of the data processing systems via the power connections. For example, the power distribution system may include power panels, transfer switches, back-up generators, batteries, power distribution units (PDUs), and/or other components that participate in distributing power (e.g., converting power and/or otherwise managing the supply of power) to the each of the power sources.

To provide power to the data processing systems, at least a portion of the PDUs of the power distribution system may be connected to the data processing systems via distinct power connections. The architecture of the power distribution system may be complex. For example, multiple PDUs of the power distribution system may each provide power to multiple data processing systems via distinct power connections. Furthermore, the architecture of the power distribution system may be designed to facilitate power distribution via the PDUs as required by each of the data processing systems in accordance with objectives for power distribution within the deployment.

For example, to manage power distribution within the deployment, limited power resources may be allocated to each of the data processing systems based on a power budget for the deployment. The power budget may be based on a mapping of the power distribution system. The mapping of the power distribution system may indicate, for example, power connections between components of the deployment, information regarding consumption and supply of power for each component of the deployment, power ratings for each of the components, and/or power caps for (e.g., maximum limits on power distribution and/or consumption by) each of the components. The power budget may be used to plan distribution of power to the deployment over time, for example, by determining (e.g., establishing, modifying) power caps for (e.g., maximum limits on power consumption by) each of the components in accordance with the objectives for power distribution.

By doing so, limited power resources may be distributed within the deployment to (i) increase efficient use of the limited power resources (e.g., preventing overloading some PDUs with power demands while underutilizing power distributed via other PDUs), (ii) reduce a likelihood of equipment damage (e.g., due to sudden spikes in power consumption), (iii) reduce costs (e.g., of power consumption, of equipment repair), and/or (iv) meet other objectives for power distribution (e.g., environmental objectives, production objectives). As a result, the deployment may be more likely to provide desired (e.g., uninterrupted, expected) computer-implemented services.

Thus, in order to meet the objectives for power distribution and/or to provide the desired computer-implemented services, a reliable (e.g., correct) mapping of the power distribution system may be required. Consequently, unexpected changes to power connections (e.g., erroneous power connections) within the deployment may cause interruptions to and/or may otherwise decrease a quality of the provided computer-implemented services. For example, during servicing of the components and/or as components are added to, replaced, and/or removed from the deployment, power connections may be modified unexpectedly due to human error and/or for other reasons. Therefore, to increase a likelihood of providing the desired computer-implemented services, device pairs (e.g., power-connected data processing systems and PDUs) may be established and enforced over time.

In general, embodiments disclosed herein may provide methods, systems, and/or devices for managing device pairs using power-based communications. To do so, the connections used to power the data processing systems via the PDUs may include multi-function connections that both supply power to the data processing systems and facilitate communication between the data processing systems and the PDUs. Using the multi-function connections, data usable for establishing and validating device pairs may be exchanged between the PDUs and the data processing systems while power is being distributed via the multi-function connection.

For example, upon establishing an initial power connection between two devices (e.g., the data processing system and the PDU), initial power may be distributed via the multi-function connection. The initial power may be sufficient for performing power onboarding processes (e.g., pairing processes, validation processes), and insufficient for the data processing system to perform desired computer-implemented services. A pairing process may be performed to establish credentials (e.g., mutual trust), and the mapping of the power distribution system may be updated to reflect the new power connection (e.g., the new device pair).

If, over time, the power connection is re-established between the devices, then a validation process may be performed using the credentials in order to validate the device pair before the PDU supplies sufficient power (e.g., a magnitude of power sufficient for the data processing system to perform the desired computer-implemented services) to the data processing system. The PDU may enter a power mode based on an outcome of the validation process in order to manage (e.g. allow, prevent) distribution of power to the data processing system, and the data processing system may enter a new power state that corresponds to the power mode in order to provide the computer-implemented services. If the validation process is unsuccessful, then a management entity may be notified of an unexpected (e.g., erroneous) power connection so that the unexpected connection may be managed timely.

By doing so, the PDUs may only distribute sufficient power to data processing systems with which they are paired and unexpected power connections may be identified in real-time, prompting the management entity to make corrections. As a result, the mapping of the power distribution system may be more likely to be reliable for use in power budgeting, the operational objectives for power distribution within the deployment may be more likely to be met, and the computer-implemented services may be more likely to be provided in a desired manner.

To provide the above-mentioned functionality, the distributed system of FIG. 1A may include data processing system 102, power distribution unit 104, management system 108, and any number of communication systems (e.g., out-of-band communication system 106A, in-band communication system 106B). The distributed system, any components thereof, and/or any other types of devices or components not shown in FIG. 1A may perform all, or a portion of the computer-implemented services independently and/or cooperatively. Each of these components is discussed below.

Data processing system 102 may include any number of data processing systems powered by the power distribution system. For example, data processing system 102 may include a single data processing system (e.g., powered via a power port of a PDU of the power distribution system), a group of data processing systems (e.g., powered via a PDU of the power distribution system), and/or a deployment of data processing systems (e.g., groups of data processing systems powered via multiple PDUs of the power distribution system). Data processing system 102 may provide computer-implemented services while hardware resources of data processing system 102 are operational (e.g., powered). For example, data processing system 102 may provide desired computer-implemented services when sufficiently powered.

To enforce power states on the hardware resources and/or to otherwise manage the operation of the hardware resources, data processing system 102 may include out-of-band components. The out-of-band components may include functionality for managing operation of the hardware resources and/or communicating with other devices using out-of-band methods (e.g., exchanging data with the other devices using out-of-band communication channels that circumvent in-band communication channels servicing the hardware resources). Refer to the discussion of FIG. 1B for more information regarding components of data processing system 102.

In the example shown in FIG. 1A, data processing system 102 may be connected to power distribution unit 104, and power may be provided to data processing system 102 from power distribution unit 104 via multi-function connection 105. Data processing system 102 may include functionality for transmitting and/or receiving data over multi-function connection 105 using power-line communication technology. For example, data processing system 102 may use multi-function connection 105 to exchange data with power distribution unit 104 when participating in power onboarding processes (e.g., pairing processes and/or validation processes).

Multi-function connection 105 may include a power connection adapted to both (i) supply power to data processing system 102, and (ii) facilitate at least one-way communication between connected entities (e.g., data processing system 102 and power distribution unit 104). For example, multi-function connection 105 may be facilitated by a power cable plugged into a power receptacle of (a power source of) data processing system 102 and into a power receptacle (e.g. a power port) of power distribution unit 104.

Power distribution unit 104 may include at least one of any number of PDUs of the power distribution system that distributes power to a deployment including data processing system 102. Power distribution unit 104 may include any type of PDU, such as a basic PDU, a smart metered PDU, a switched PDU, an intelligent rack PDU, etc., and may include any number and/or type of power ports (e.g., power receptacles). In addition to use in PDUs, other types of power provisioning devices may include similar functionality. For example, other types of power provisioning devices may include smart outlets, smart receptacles, smart surge protectors, smart power strips, and/or other devices that may regulate distribution of power from a source of power (e.g., utility level power).

Power distribution unit 104 may supply power to at least data processing system 102 (e.g., as well as other data processing systems of the deployment). For example, power distribution unit 104 may supply power to data processing system 102 via multi-function connection 105, and to other data processing systems via distinct multi-function connections (not shown) similar to multi-function connection 105.

To participate in device pairing and validation processes, power distribution unit 104 may include functionality for communicating with operably connected devices. For example, power distribution unit 104 may include a component such as a power manager (e.g., a microcontroller) adapted to transmit data to data processing system 102 (and/or to obtain data from data processing system 102) via multi-function connection 105 using power-line communication technology.

Power distribution unit 104 may use multi-function connection 105 to (i) monitor and/or report (e.g., to a remote management entity) magnitudes of power consumed by power-connected data processing systems over time, and/or (ii) enforce policies regarding limits on power made available to each of the power-connected data processing systems. For example, the policies may specify power modes for power distribution unit 104. The power modes may define limitations on power supplied to data processing systems over time in order to prevent power consumption spikes, unexpected increases in power consumption, and/or to balance power demands across the deployment. Refer to the discussion of FIG. 1C for more information regarding power distribution by power distribution unit 104.

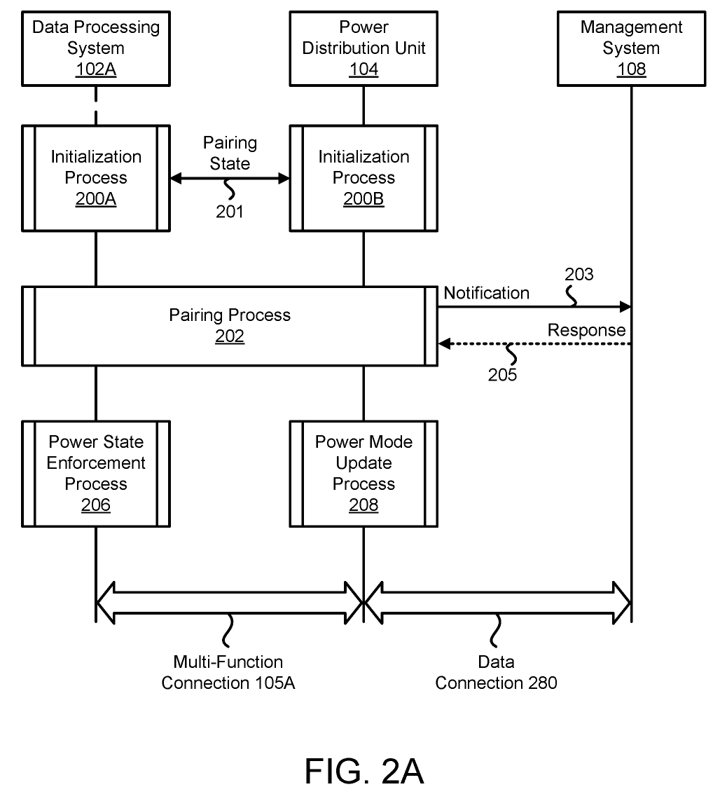

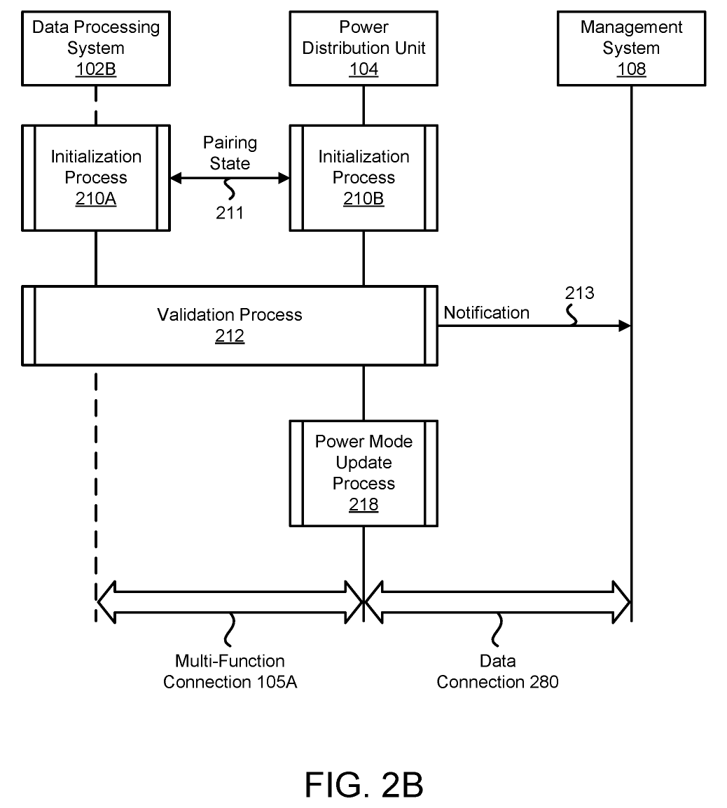

Power distribution unit 104 may communicate with other entities regarding paired devices (e.g., power-connected data processing systems), and/or other information (e.g., power distribution to and/or power consumption by the paired devices). For example, power distribution unit 104 may (i) provide power information (e.g., information usable for maintaining the mapping of the power distribution system) and/or notifications regarding outcomes of validation processes to management system 108, and/or (iii) obtain responses from management system 108 regarding new device pairings and/or power budgeting for paired devices. Power distribution unit 104 may communicate with management system 108, for example, via a data connection. The data connection may include any type of connection usable for transmitting and/or receiving data over any type of communication system (e.g., shown as data connection 280 in FIGS. 2A-2B).

Management system 108 may include any number of systems that provide various services for managing the deployment including data processing system 102, such as power budgeting services, power distribution services, workload assignment services, etc. For example, management system 108 may maintain (e.g., generate, update) the mapping of the power distribution system based on power information provided by data processing system 102 and power distribution unit 104.

For example, management system 108 may (i) obtain power information for components of the deployment (e.g., information regarding new device pairings), (ii) update the mapping of the power distribution system based, in part, on the power information, (iii) obtain information regarding outcomes of validation processes, (iv) notify management entities (e.g., via a service console, and/or other devices) of unexpected power connections within the deployment (e.g., indicated by unsuccessful validation processes), and/or (v) provide information regarding new device pairings and/or power budgeting for paired devices to the components. For example, management system 108 may provide information to data processing system 102 via power distribution unit 104.

To participate in device pairing and/or validation processes, data processing system 102 may (i) identify an operable connection to a PDU of the deployment (e.g., power distribution unit 104), (ii) identify a pairing state for the PDU (e.g., paired or unpaired), (iii) determine whether a pairing process and/or a validation process needs to be performed (e.g., based on the pairing state for the PDU), (iv) participate (e.g., with the PDU) in the pairing process to update the pairing state for the PDU, (v) participate (e.g., with the PDU) in the validation process to identify a new power state for data processing system 102 and/or enforce the new power state (e.g., on at least hardware resources of data processing system 102), and/or (vi) provide computer-implemented services using the hardware resources while the hardware resources are operating in the new power state.

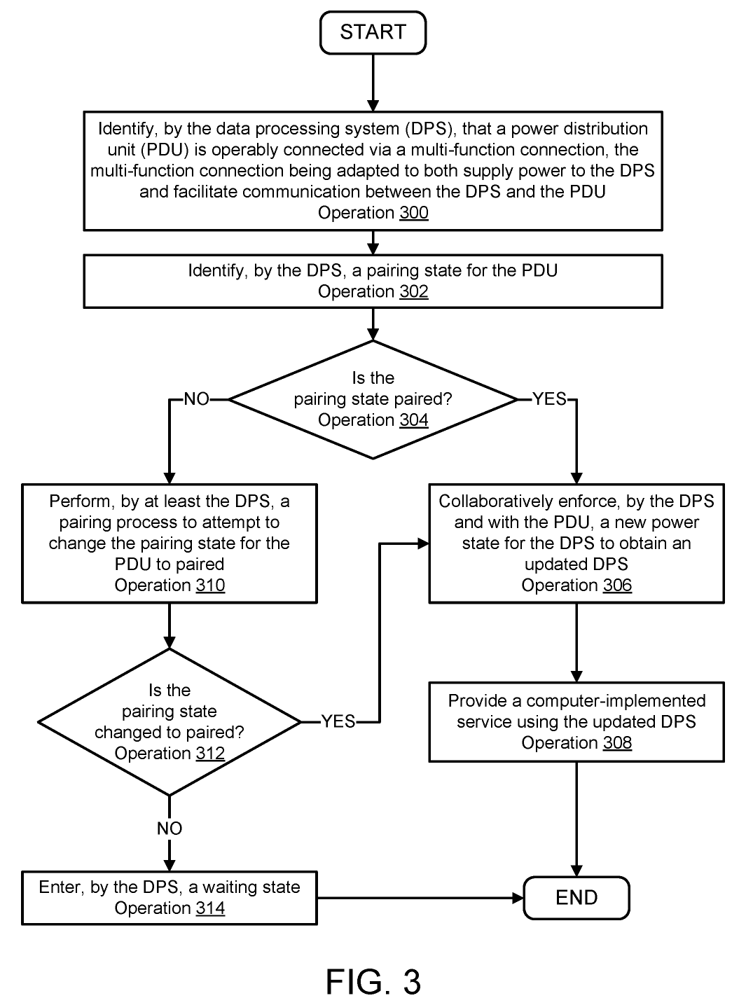

When providing their functionality, any of data processing system 102, power distribution unit 104, management system 108, and/or components thereof may perform all, or a portion of the actions and methods illustrated in FIGS. 2A-3.

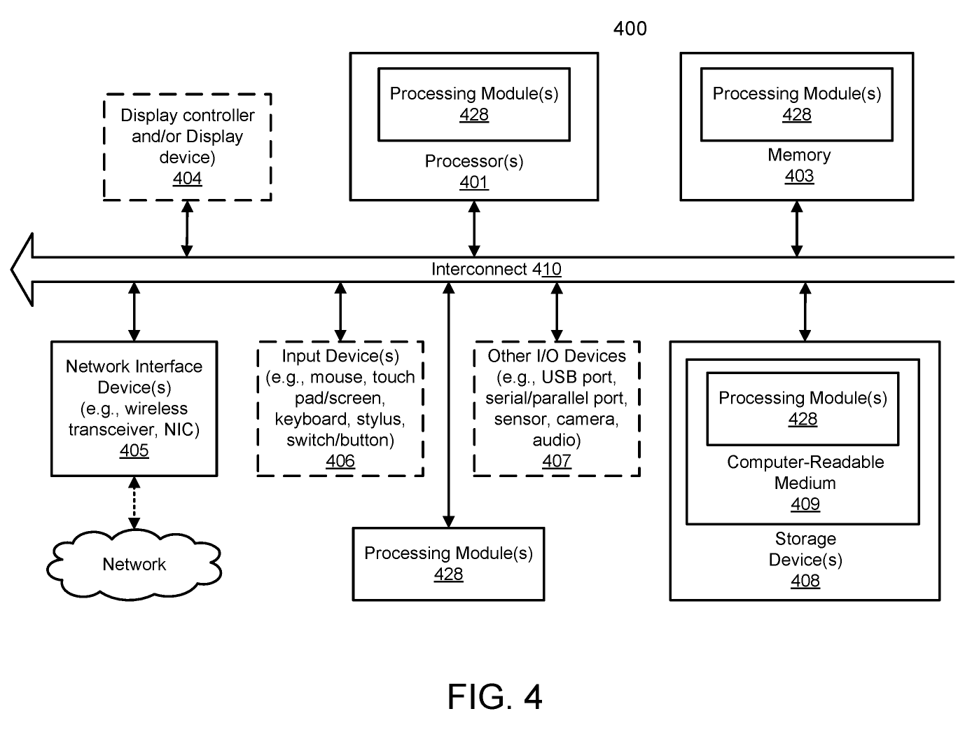

Any of data processing system 102, power distribution unit 104, and management system 108 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., smartphone), an embedded system, local controllers, an edge node, and/or any other type of data processing device or system. For additional details regarding computing devices, refer to the discussion of FIG. 4.

Any of the components illustrated in FIG. 1A may be operably connected to each other (and/or components not illustrated) with a communication system. The communication system may facilitate communications between the components of FIG. 1A. In an embodiment, the communication system includes one or more networks that facilitate communication between any number of components. The networks may include wired networks and/or wireless networks (e.g., and/or the Internet). The networks and communication devices may operate in accordance with any number and types of communication protocols (e.g., such as the Internet protocol).

For example, the communication system may include out-of-band communication system 106A and in-band communication system 106B. Out-of-band communication system 106A may facilitate communication between the out-of-band components of data processing system 102, power distribution unit 104, management system 108, and/or other devices connected to out-of-band communication system 106A; whereas in-band communication system 106B may facilitate communication between in-band components of data processing system 102, management system 108, and other entities (e.g., devices) connected to in-band communication system 106B.

While illustrated separately in FIG. 1A, out-of-band communication system 106A and in-band communication system 106B may be the same communication system. Although not shown in FIG. 1A, power distribution unit 104 may be connected to in-band communication system 106B.

While illustrated in FIG. 1A as including a limited number of specific components, a system in accordance with an embodiment may include fewer, additional, and/or different components than those illustrated therein.

Turning to FIG. 1B, a diagram illustrating a data processing system in accordance with an embodiment is shown. Data processing system 102 shown in FIG. 1B may be similar to any of the computing devices shown in FIG. 1A.

To provide computer-implemented services, data processing system 102 may include any quantity of hardware resources 150. Hardware resources 150 may be in-band (hardware) components, and may include a processor operably coupled to memory, storage, and/or other hardware components.

The processor may host various management entities such as operating systems, drivers, network stacks, and/or other software entities that provide various management functionalities. For example, the operating system and drivers may provide abstracted access to various hardware resources. Likewise, the network stack may facilitate packaging, transmission, routing, and/or other functions with respect to exchanging data with other devices.

For example, the network stack may support transmission control protocol/internet protocol communication (TCP/IP) (e.g., the Internet protocol suite) thereby allowing the hardware resources 150 to communicate with other devices via packet switched networks and/or other types of communication networks.

The processor may also host various applications that provide the computer-implemented services. The applications may utilize various services provided by the management entities and use (at least indirectly) the network stack to communicate with other entities.

However, use of the network stack and the services provided by the management entities may place the applications at risk of indirect compromise. For example, if any of these entities trusted by the applications are compromised, then these entities may subsequently compromise the operation of the applications. For example, if various drivers and/or the communication stack are compromised, then communications to/from other devices may be compromised. If the applications trust these communications, then the applications may also be compromised.

For example, to communicate with other entities, an application may generate and send communications to a network stack and/or driver, which may subsequently transmit a packaged form of the communication via channel 170 to a communication component, which may then send the packaged communication (in a yet further packaged form, in some embodiments, with various layers of encapsulation being added depending on the network environment outside of data processing system 102) to another device via any number of intermediate networks (e.g., via wired/wireless channels 176 that are part of the networks).

To reduce the likelihood of the applications and/or other in-band entities from being indirectly compromised, data processing system 102 may include management controller 152 and network module 160. Each of these components of data processing system 102 is discussed below.

Management controller 152 may be implemented, for example, using a system on a chip or other type of independently operating computing device (e.g., independent from the in-band components, such as hardware resources 150 of a host data processing system 102). Management controller 152 may provide various management functionalities for data processing system 102. Management controller 152 may, for example, monitor various ongoing processes performed by the in-band components, may manage power distribution, thermal management, and/or may perform other functions for managing data processing system 102.

To do so, management controller 152 may be operably connected to various components via sideband channels 174 (in FIG. 1B, a limited number of sideband channels are included for illustrative purposes, it will be appreciated that management controller 152 may communicate with other components via any number of sideband channels). The sideband channels may be implemented using separate physical channels, and/or with a logical channel overlay over existing physical channels (e.g., logical division of in-band channels).

The sideband channels may allow management controller 152 to interface with other components and implement various management functionalities such as, for example, general data retrieval (e.g., to snoop ongoing processes), telemetry data retrieval (e.g., to identify a health condition/other state of another component), function activation (e.g., sending instructions that cause the receiving component to perform various actions such as displaying data, adding data to memory, causing various processes to be performed), and/or other types of management functionalities.

For example, when managing power consumption by hardware resources 150, management controller 152 may use sideband channels 174 to initiate and/or perform, at least in part (e.g., in cooperation with hardware resources 150), actions for enforcing a new power state on hardware resources 150.

To reduce the likelihood of indirect compromise of an application hosted by hardware resources 150, management controller 152 may, for example, enable information from other devices to be provided to the application without traversing the network stack and/or management entities of hardware resources 150. To do so, the other devices may direct communications including the information to management controller 152.

Management controller 152 may then, for example, send the information via sideband channels 174 to hardware resources 150 (e.g., to store it in a memory location accessible by the application, such as a shared memory location, a mailbox architecture, or other type of memory-based communication system) to provide it to the application. Thus, the application may receive and act on the information without the information passing through potentially compromised entities. Consequently, the information may be less likely to also be compromised, thereby reducing the possibility of the application becoming indirectly compromised. Similarly, processes may be used to facilitate outbound communications from the applications.

Management controller 152 may be operably connected to communication components of data processing system 102 via separate channels (e.g., 172) from the in-band components, and may implement or otherwise utilize a distinct and independent network stack (e.g., TCP/IP). Consequently, management controller 152 may communicate with other devices independently of any of the in-band components (e.g., does not rely on any hosted software, hardware components, etc.). Accordingly, compromise of any of hardware resources 150 and hosted components may not result in indirect compromise of any management controller 152, and entities hosted by management controller 152.

To facilitate communication with other devices, data processing system 102 may include network module 160. Network module 160 may provide communication services for in-band components and out-of-band components (e.g., management controller 152) of data processing system 102. To do so, network module 160 may include traffic manager 162, and interfaces 164.

Traffic manager 162 may include functionality to (i) discriminate traffic directed to various network endpoints advertised by data processing system 102, and (ii) forward the traffic to/from the entities associated with the different network endpoints. For example, to facilitate communications with other devices, network module 160 may advertise different network endpoints (e.g., different media access control address/internet protocol addresses) for the in-band components and out-of-band components. Thus, other entities may address communications to these different network endpoints. When such communications are received by network module 160, traffic manager 162 may discriminate and direct the communications accordingly (e.g., over channel 170 or channel 172, in the example shown in FIG. 1B, it will be appreciated that network module 160 may discriminate traffic directed to any number of data units and direct it accordingly over any number of channels).

Accordingly, traffic directed to management controller 152 may never flow through any of the in-band components. Likewise, outbound traffic from the out-of-band component may never flow through the in-band components.

To support inbound and outbound traffic, network module 160 may include any number of interfaces 164. Interfaces 164 may be implemented using any number and type of communication devices which may each provide wired and/or wireless communication functionality. For example, interfaces 164 may include a wireless wide area network (WWAN) card, a Wi-Fi card, a wireless local area network card, a wired local area network card, an optical communication card, and/or other types of communication components. These components may support any number of wired/wireless channels 176.

Thus, from the perspective of an external device, the in-band components and out-of-band components of data processing system 102 may appear to be two independent network entities that may be independently addressable and/or otherwise unrelated to one another.

To power hardware resources 150 and/or other components of data processing system 102, data processing system 102 may include power source 180. Power source 180 may include any type of power source (e.g., a power supply, a battery, etc.) and may distribute power to hardware resources 150 and/or the other components (e.g., management controller 152) via power rails 186 and/or 184. Power source 180 may provide an amount of power consistent with ratings for power source 180 (e.g., maximum power output, efficiency). Power source 180 may obtain a supply of power from a PDU (e.g., power distribution unit 104) via a multi-function connection (e.g., multi-function connection 105, multi-function connections 105A-105N shown in FIG. 1C and in FIGS. 2A-2B.). For example, multi-function connection 105 may be connected to a receptacle of power source 180 and a receptable (e.g., a power port) of power distribution unit 104.

Power source 180 may include components for obtaining power and/or data from power distribution unit 104. For example, power source 180 may include components adapted to filter data signal from power signal to obtain responses from power distribution unit 104. Power source 180 may participate in power onboarding for data processing system 102. To do so, power source 180 may include components for exchanging data with power distribution unit 104 over multi-function connection 105.

For example, power source 180 may include a component adapted to encode data onto (or decode data from) a carrier signal distributed via multi-function connection 105 to facilitate communications with power distribution unit 104. The data may include information such as an identifier for data processing system 102 and/or a component thereof (e.g., an identifier for power source 180), credentials, other signed data structures, and/or other information usable to pair and/or validate data processing system 102 with power distribution unit 104. For example, the information may be stored in local memory of power source 180 and/or by other components of data processing system 102.

To manage power distribution to hardware resources 150, data processing system 102 may include power manager 182. Power manager 182 may manage power distribution to hardware resources 150 from power source 180 (e.g., supplied via power rail 184 and/or power rail 186). To do so, power manager 182 may communicate with power source 180 and/or management controller 152 via sideband channels 174.

For example, power manager 182 may (i) obtain and/or analyze information obtained from power distribution unit 104 (e.g., via power source 180 and over sideband channels 174) to identify new power states for data processing system 102, (ii) communicate with management controller 152 regarding power states for data processing system 102 (e.g., provide information to management controller 152 for analysis), (iii) monitor power consumption by hardware resources 150 over time, (iv) report changes in power consumption by power source 180 over time to management controller 152 and/or other components, and/or (v) perform other actions relating to power consumption by portions of hardware resources 150 (e.g., actions for enforcing new power states on hardware resources 150).

Any of management controller 152, power manager 182, power source 180, and/or other components of data processing system 102 may store (e.g., in local memory) and/or manage identification information (e.g., identifiers, credentials) for data processing system 102. Thus, when providing the identification information to power distribution unit 104 over multi-function connection 105, the identification information may first be provided to power source 180 by another component of data processing system 102 via sideband channels 174.

To facilitate management of data processing system 102 over time, hardware resources 150, management controller 152 and/or network module 160 may be positioned in separately controllable power domains. By being positioned in these separate power domains, different subsets of these components may remain powered while other subsets are unpowered.

For example, management controller 152 and network module 160 may remain powered while hardware resources 150 are unpowered. Consequently, management controller 152 may remain able to communicate with other devices even while hardware resources 150 are inactive. Similarly, management controller 152 may perform various actions while hardware resources 150 are not powered and/or are otherwise inoperable, unable to cooperatively perform various process, are compromised, and/or are unavailable for other reasons.

To implement the separate power domains, power source 180 may separately supply power to the power rails (e.g., power rail 184, power rail 186) that power the respective power domains. Power from the power source 180 may be selectively provided to the separate power rails to selectively power the different power domains. Management controller 152 may cooperate with power manager 182 to manage supply of power to these power domains. Management controller 152 may communicate with power manager 182 via sideband channels 174 and/or via other means.

In FIG. 1B, an example implementation of separate power domains using power rails 184-186 is shown. The power rails may be implemented using, for example, bus bars or other types of transmission elements capable of distributing electrical power. While not shown, it will be appreciated that the power domains may include various power management components (e.g., fuses, switches, etc.) to facilitate selective distribution of power within the power domains.

Turning to FIG. 1C, a diagram illustrating a power distribution system in accordance with an embodiment is shown. Power distribution unit 104 shown in FIG. 1C may be similar to any of the computing devices shown in FIG. 1A. The power distribution system may include power source 190, power distribution unit 104, and/or other components (not shown).

The power distribution system may distribute power to a deployment of data processing systems, such as deployment 198. Deployment 198 may include any number of data processing systems (e.g., similar to data processing system 102). For example, deployment 198 may be subdivided into groups (e.g., racks) of data processing systems for powering purposes. In FIG. 1C, a group of data processing systems is shown to include power sources 180A-180N. Power sources 180A-180N may be powered via power distribution unit 104 (e.g., a rack PDU).

Power distribution unit 104 may include any PDU included in the power distribution system. Power distribution unit 104 may include any number of power ports 192 (e.g., 192A-192N) by which power is provided to power sources (e.g., 180A-180N) via distinct multi-function connections. Power sources 180A-180N may be similar to power source 180 of FIG. 1B, and multi-function connections 105A-105N may be similar to multi-function connection 105 of FIG. 1B.

The multi-function connections (e.g., 105A-105N) may be adapted to supply power to connected components of data processing systems (e.g., power sources, intermediary devices) and facilitate communication (e.g., data exchange) between the components and power distribution unit 104. To facilitate data exchange over multi-function connections 105A-105N, any of power ports 192 may include special hardware (e.g., filters, modulators, and/or other hardware circuitry, not shown) for decoding data obtained via a carrier signal of a corresponding multi-function connection and/or encoding data onto the carrier signal.

In the example shown in FIG. 1C, power source 180A of a first data processing system of deployment 198 may be connected to power port 192A via multi-function connection 105A. Therefore, the first data processing system (e.g., power source 180A) may communicate with and receive power from power distribution unit 104 via multi-function connection 105A. A second data processing system of deployment 198 may include power source 180N and intermediary device 196. The second data processing system (e.g., power source 180N) may receive power from intermediary device 196 via power connection 250. Power connection 250 may include any type of connection adapted to provide power to power source 180N from intermediary device 196 (e.g., a power cable). Intermediary device 196 may be connected to power port 192N via multi-function connection 105N, and may communicate with and receive power from power distribution unit 104 via multi-function connection 105N.

For example, the second data processing system may be a legacy device that is not adapted to participate in power onboarding. In other words, power source 180N may not include (i) functionality for transmitting and/or receiving data via a multi-function connection, and/or (ii) information suitable for performing pairing and/or validation processes may not be available to (components of) the second data processing system. Therefore, the second data processing system may include intermediary device 196, and intermediary device 196 may be adapted to participate in power onboarding on behalf of the second data processing system.

Intermediary device 196 may include any device adapted to pass power obtained from a PDU to a power source of a data processing system. For example, intermediary device 196 may include power draw limiting circuitry to manage (magnitudes of) power provided to the power source from the PDU. Intermediary device 196 may be external to the data processing system and may be a device such as a dongle and/or an adapter. Intermediary device 196 may be connected to the PDU via a multi-function connection and connected to the power source via a power connection 250. In the example shown in FIG. 1C, intermediary device 196 is connected to power port 192N via multi-function connection 105N and connected to power source 180N via power connection 250. As shown, power source 180N is not connected to the PDU via any multi-function connections.

Intermediary device 196 may include functionality similar to power source 180 of FIG. 1B. For example, intermediary device 196 may include components for obtaining power and data from power distribution unit 104 via multi-function connection 105N (e.g., components adapted to filter data signal from power signal). Intermediary device 196 may participate in pairing and/or validation processes on behalf of the second data processing system by, for example, providing identification information to power distribution unit 104 via multi-function connection 105N.

Power distribution unit 104 may obtain power via power connection 191 from power source 190. Power connection 191 may include any type of connection usable for transmitting power from power source 190 to power distribution unit 104. Power source 190 may include one or more components usable to convert utility level power (e.g., power from a utility power grid) to data center level power (e.g., power usable by a data center and/or to power any number of deployments (e.g., deployment 198) and/or data processing systems. For example, power source 190 may include a complicated architecture of one or more connected components (e.g., transformers, switches, power and/or bypass panels, power distribution units, batteries, back-up generators) and may connect to a large-scale source of power.

To manage power distribution from power source 190 to the group of power sources (e.g., 180A-180N), power distribution unit 104 may include power manager 194. Power manager 194 may use data channels 193 to manage power distribution. For example, power manager 194 may use data channels 193 to (i) monitor power consumption via each of power ports 192, (ii) obtain data from and/or provide data to power ports 192 (e.g., identification information, responses, and/or instructions for managing power distribution via power ports 192), and/or (iii) perform other actions relating to power distribution and/or management.

Power manager 194 may include functionality for exchanging data with other devices remote to power distribution unit 104. For example, power distribution unit 104 may include network components (not shown) and may be connected to a communication system (e.g., out-of-band communication system 106A of FIG. 1A). Power manager 194 may provide data (e.g., via communication channels, not shown) to a network component of power distribution unit 104 for transmission to a management entity (e.g., management system 108).

Power manager 194 may manage and/or participate in pairing and/or validation processes for data processing systems of power sources 180A-180N (e.g., connected data processing systems). For example, to participate in a pairing process with power source 180A, power manager 194 may (i) enter a pairing mode where information is exchanged with power source 180A via multi-function connection 105A (e.g., information indicating a pairing state for power port 192A), (ii) establish credentials with power source 180A, (iii) store the credentials (e.g., in local memory), (iv) notify the management entity (e.g., management system 108) of an outcome of the pairing process (e.g., so that the management entity can maintain a mapping of the power distribution system), and/or (v) update a pairing state for power distribution unit 104 (e.g., paired or unpaired, depending on the outcome of the pairing process).

To participate in a validation process with power source 180A, power manager 194 may, for example, (i) validate portions of identification information for power source 180A using the stored credentials, (ii) obtain an outcome of the validation process, (iii) identify a power modes for power port 192A based in part, on the outcome of the validation process, (iv) enforce the power mode on power port 192A, and/or (v) provide information regarding the outcome of the validation processes to the management entity (e.g., management system 108).

While a power mode is being enforced on power port 192A, power distributed via power port 192A to power source 180A may be provided in accordance with power characteristics of the power mode. For example, when the power mode is being enforced, (i) a magnitude of power demanded by power source 180A may be provided (e.g., always, or for a period of time), (ii) power may not be provided to power source 180A (e.g., always, or for a period of time), and/or (iii) a maximum magnitude of power may be provided to power source 180A (e.g., always, or for a period of time, defined by tiers of power privileges and/or current loads on power distribution unit 104 or other components of the power distribution system).

For the purposes of clarity, the example shown in FIG. 1C includes one power distribution unit 104 powering one group (e.g., one rack) of power sources (e.g., 180A-180N) of deployment 198. However, in practice, it may be appreciated that a power distribution system may include multiple PDUs (e.g., similar to power distribution unit 104), each providing power to other groups of power sources of deployment 198 not shown in FIG. 1C.

To further clarify embodiments disclosed herein, interaction diagrams in accordance with an embodiment are shown in FIGS. 2A-2B. The interaction diagrams may illustrate how data may be obtained and used within the system of FIGS. 1A-1C.

In the interaction diagrams, processes performed by and interactions between components of a (distributed) system in accordance with an embodiment are shown. In the diagrams, components of the system are illustrated using a first set of shapes (e.g., 102A, 104, etc.), located towards the top of each figure. Lines descend from these shapes. Lines drawn in dashing may indicate, for example, that the component is unpowered, while solid lines may indicate that the component is powered. Processes performed by the components of the system are illustrated using a second set of shapes (e.g., 200A, 200B) superimposed over these lines. Processes superimposed over lines of two or more components (e.g., 202, 212) may indicate cooperative operation of the components during the processes (e.g., data exchange between the components).

Interactions (e.g., communication, data transmissions, etc.) between the components of the system are illustrated using a third set of shapes (e.g., 201, 203) that extend between the lines. The third set of shapes may include lines terminating in one or two arrows. Lines terminating in a single arrow may indicate that one-way interactions (e.g., data transmission from a first component to a second component) occur, while lines terminating in two arrows may indicate that multi-way interactions (e.g., data transmission between two components) occur. Some of the third set of shapes are drawn in dashing to indicate that corresponding interactions are optional and/or may not occur (e.g., 205).

Thick arrows (e.g., multi-function connection 105A, data connection 280) may indicate communication channels that facilitate multi-way interactions (e.g., data transmission between two components).

Generally, the processes and interactions are temporally ordered in an example order, with time increasing from the top to the bottom of each page. For example, the interaction labeled as 203 may occur prior to the interaction labeled as 205. However, it will be appreciated that the processes and interactions may be performed in different orders, any may be omitted, and other processes or interactions may be performed without departing from embodiments disclosed herein.

Some portions of the lines descending from some of the first set of shapes (e.g., 150) are drawn in dashing to indicate, for example, that the corresponding components may be in an undesired state. For example, the corresponding components may be compromised and/or may not be (i) operable, (ii) powered on, (iii) present in the system, and/or (iv) participating in operation of the system for other reasons.

Turning to FIG. 2A, a first interaction diagram in accordance with an embodiment is shown. The first interaction diagram may illustrate processes and interactions that may occur during pairing of a data processing system with a PDU. In the example shown in FIG. 2A, data processing system 102A may include functionality for participating in device pairing.

For example, data processing system 102A may store identification information usable to establish an identity of data processing system 102A with power distribution unit 104, and may be enabled to communicate with power distribution unit 104 using power-line communication technology. However, in other examples where data processing system 102A does not include native functionality for participating in device pairing, data processing system 102A may include an intermediary device that may participate in the pairing process on behalf of data processing system 102A. Refer to FIG. 1C for more information regarding intermediary devices.

To determine whether a pairing process needs to be performed, data processing system 102A may perform initialization process 200A and/or power distribution unit 104 may perform initialization process 200B. Initialization processes 200A and/or 200B may be initiated when a power connection is established between power distribution unit 104 and data processing system 102A. The power connection may be established over multi-function connection 105A (e.g., similar to multi-function connection 105 of FIG. 1B and/or multi-function connections 105A-105N of FIG. 1C). For example, the power connection may be established when a power cable connected to (e.g., plugged into a power receptacle of) a power source of data processing system 102A is plugged into a power port of power distribution unit 104.

Prior to performance of initialization process 200B, power distribution unit 104 may be operating in a default power mode. For example, the default power mode may include a power-off mode (e.g., providing no power via the power port) or a low-power mode (e.g., providing a small magnitude of power sufficient to detect a change in electrical characteristics of the power port and/or devices connected to the power port over time). To prompt performance of initialization process 200B, power distribution unit 104 may detect that the power connection has been established. For example, if power distribution unit 104 is operating in the power-off mode, then the connection may be detected via a mechanical switch, or if power distribution unit 104 is operating in the low-power mode, then the connection may be detected based on a change in electrical characteristics of the power port (e.g., an increase in power draw via the power port).

During initialization process 200B, the power mode may be updated for power distribution unit 104 (e.g., from the default power mode) in accordance with policies for a power distribution system of which power distribution unit 104 is a component. For example, if the default power mode for the power port of power distribution unit 104 facilitating multi-function connection 105A is unsuitable for performing device pairing (e.g., in a power-off mode), then the power port may be placed in a power mode suitable for device pairing (e.g., a pairing mode that may include a low-power mode).

During initialization processes 200A and/or 200B, data processing system 102A may begin to obtain power from power distribution unit 104 via multi-function connection 105A in accordance with the policies (as indicated by the solid line descending from the shape representing initialization process 200A). For example, the policies may specify that initial power provided via the power port during initialization process 200B (e.g., initial power obtained by data processing system 102A during initialization process 200A) may be a magnitude of power sufficient for performing device pairing and insufficient for data processing system 102A to operate in a desired manner, and the initial power may be provided to data processing system 102A for a period of time estimated to be sufficient for device pairing to complete (and/or until the power connection is terminated).

Prior to performance of initialization process 200A, data processing system 102A may be unpowered (e.g., in a power-off state) as indicated by a dashing line descending from the shape representing data processing system 102A (above initialization process 200A). To prompt performance of initialization process 200A, data processing system 102A may identify that the power connection has been established with power distribution unit 104 via multi-function connection 105A. For example, the connection may be detected based on a change in electrical characteristics of a power source of data processing system 102A (e.g., an increase in power supplied to the power source of data processing system 102A) when the initial power is provided to the power source by power distribution unit 104.

During initialization process 200A, data processing system 102A (and/or power distribution unit 104) may determine whether pairing process 202 needs to be performed based on a pairing state for (the power port of) power distribution unit 104. To identify the pairing state for power distribution unit 104 so, data processing system 102A may request information regarding the pairing state from power distribution unit 104. For example, the power distribution unit 104 may store data structures that include a flag (e.g., a pairing flag) indicating whether the device is paired or unpaired, and power distribution unit 104 may not participate in a pairing process while the flag is set to paired. Therefore, data processing system 102A may request the data structure and/or a value of the data structure (e.g., the pairing flag for the power port) from power distribution unit 104 to identify the pairing state.

At interaction 201, data processing system 102A and power distribution unit 104 may exchange data (e.g., a request for contents of the data structure, the requested contents) over multi-function connection 105A via (i) transmission via a message, (ii) storing in a storage with subsequent retrieval by power distribution unit 104 and/or data processing system 102A, (iii) a publish-subscribe system where at least one of power distribution unit 104 and/or data processing system 102A subscribes to updates from the other thereby causing a copy of the data to be propagated to power distribution unit 104 and/or data processing system 102A, and/or (iv) other processes. For example, data processing system 102A may provide a request for the pairing state to power distribution unit 104, and power distribution unit 104 may provide the pairing state to data processing system 102A. The pairing state may be used to determine whether pairing process 202 is performed.

For example, if the data exchanged at interaction 201 indicates that the pairing state for power distribution unit 104 is paired, then data processing system 102A may not perform pairing process 202 (e.g., instead, data processing system 102A may perform a validation process as described with respect to the example shown in FIG. 2B). However, if the data exchanged at interaction 201 indicates that the pairing state for power distribution unit 104 is unpaired, then data processing system 102A may perform pairing process 202 to attempt to change the power state for power distribution unit 104 to paired.

Pairing process 202 may be performed while (the initial) power is being distributed via multi-function connection 105A and/or may include a cooperative process between data processing system 102A and power distribution unit 104. During pairing process 202, data may be exchanged between data processing system 102A and power distribution unit 104 via multi-function connection 105A (e.g., a handshake may be performed). For example, as discussed with respect to FIGS. 1A-1C, to exchange data, a power manager of power distribution unit 104 and/or a power source of data processing system 102A may each encode data onto and/or decode data from a carrier signal of multi-function connection 105A.

For example, data processing system 102A (e.g., components thereof) may store identification information usable to establish an identity of data processing system 102A to power distribution unit 104. The identification information may include (i) an identifier for data processing system 102A, (ii) power capabilities for data processing system 102A (e.g., ratings for the power source), (iii) power consumption requirements for data processing system 102A, and/or (iv) other types of information usable to establish the device pairing. Data processing system 102A may provide the identification information to power distribution unit 104 (e.g., to the power ports) over multi-function connection 105A using methods similar to those described with interaction 201, and while the initial power is being distributed via multi-function connection 105A.

During pairing process 202, data processing system 102A and power distribution unit 104 may generate and/or store cryptographically verifiable information (e.g., data processing system 102A and power distribution unit 104 may negotiate a set of credentials). For example, the devices may agree on a symmetric cryptographic key using a Diffie-Helman key exchange method and/or other cryptographic methods for generating credentials. The credentials may certify to one device that the other device has possession of the shared key and/or may be used to enable secure (e.g., encrypted) communications via multi-function connection 105A.

During pairing process 202, data may be exchanged with management system 108 via power distribution unit 104. To do so, power distribution unit 104 may be operably connected to management system 108 via data connection 280 (e.g., any type of connection usable to transmit and/or receive data, such as a network connection). For example, during pairing process 202, a notification may be obtained (e.g., generated), indicating a status of the pairing process (e.g., that the devices are attempting to pair, have successfully paired, or have failed to pair). For example, the notification may include information usable for the management system 108 to maintain a mapping of the power distribution system and/or to perform power budgeting tasks (e.g., identification information for both devices, reported power distribution and/or consumption by the devices).

At interaction 203, power distribution unit 104 may provide the notification to management system 108 over data connection 280 via (i) transmission via a message, (ii) storing in a storage with subsequent retrieval by management system 108, (iii) a publish-subscribe system where management system 108 subscribes to updates from power distribution unit 104 thereby causing a copy of the notification to be propagated to management system 108, and/or (iv) other processes. By doing so, management system 108 may use information included in the notification to (i) verify the device pairing is consistent with power connections defined by the mapping of the power distribution system, and/or (ii) to update the mapping of the power distribution system.

In a first example, management system 108 may identify that the device pairing is not consistent with the power connections defined by the mapping of the power distribution system, and may generate a response indicating so. Management system 108 may provide the response to power distribution unit 104 and/or other entities (e.g., via a service console running on other devices used by technicians, administrators, and/or operators of the deployment) so that the unexpected power connection may be managed (e.g., corrected).

In a second example, management system 108 may not identify an issue regarding the device pairing (e.g., with respect to policies and/or the mapping of the power distribution system), and the response may indicate acknowledgement of the device pairing. The response may include other types of information such as (i) power privileges for data processing system 102A, (ii) power caps for data processing system 102A and/or power distribution unit 104 (e.g., determined based on a power budget for the power distribution system), and/or (iii) other information indicating characteristics of power warranted for data processing system 102A.

At interaction 205, management system 108 may provide the response to power distribution unit 104 over data connection 280 via (i) transmission via a message, (ii) storing in a storage with subsequent retrieval by power distribution unit 104, (iii) a publish-subscribe system where power distribution unit 104 subscribes to updates from management system 108 thereby causing a copy of the response to be propagated to power distribution unit 104, and/or (iv) other processes. Upon obtaining the response, power distribution unit 104 may provide at least a portion of the response to data processing system 102A via multi-function connection 105A using methods similar to those described with respect to interaction 201 and while the initial power is being distributed via multi-function connection 105A.

During pairing process 202, if pairing is unsuccessful (e.g., the response indicates the pairing is inconsistent with the mapping of the power distribution system, or for other reasons), then the pairing state for power distribution unit 104 may not be changed to paired (e.g., the pairing flag may not be cleared). However, if during pairing process 202, pairing is successful (e.g., the response indicates the pairing is consistent with the mapping of the power distribution system, or for other reasons), then the pairing state for power distribution unit 104 may be changed to paired (e.g., the pairing flag may be cleared).

Based on the pairing state of power distribution unit 104 (e.g., based on an outcome of pairing process 202), power distribution unit 104 may enter a new power mode. To do so, power distribution unit 104 may perform power mode update process 208. During power mode update process 208, power distribution unit 104 may identify the new power mode (e.g., based on information in the response, and/or policies keyed to outcomes of pairing process 202), and enforce the new power mode on the power port facilitating multi-function connection 105A.

For example, if pairing is successful, then power distribution unit 104 may increase a magnitude of power distributed via the power port (e.g., over time for power ramping) in order to place the power port in the new power mode (from the pairing mode). The increased magnitude of power may be sufficient for data processing system 102A to operate in the desired manner. Or, for example, if pairing was unsuccessful, then power distribution unit 104 may continue to only provide the initial power (e.g., insufficient for data processing system 102A to operate in the desired manner), or cease providing power to data processing system 102A.

Based on the pairing state of power distribution unit 104, (e.g., based on an outcome of pairing process 202), data processing system may enforce a new power state on its hardware resources. To do so, data processing system 102A may perform power state enforcement process 206. During power state enforcement process 206, the new power state for data processing system 102A may be collaboratively enforced by data processing system 102A and power distribution unit 104. For example, power distribution unit 104 may provide data processing system 102A with information (e.g., the response from management system 108, characteristics of power warranted for data processing system 102A) indicating the new power state for data processing system 102A. For example, data processing system 102A may be provided with a (new) power cap.

During power state enforcement process 206, power consumption by data processing system 102A may be modified. To do so, instructions for enforcing the new power state on at least hardware resources of data processing system 102A may be obtained and/or executed. For example, a power manager of data processing system 102A may obtain, execute and/or provide instructions to other components of data processing system 102A (e.g., the hardware resources, a management controller). Execution of the instructions may modify power consumption by data processing system 102A.

The instructions may be based on characteristics of power indicated by the response, and may include instructions for (i) modifying configuration settings of the hardware resources (e.g., increasing or reducing clock speeds), (ii) activating (or deactivating) components of the hardware resources (e.g., a graphics processing unit), (iii) activating (or deactivating) portions of components of the hardware resources (e.g., a core of a multi-core processor), and/or (iv) performing other actions to modify power consumption by the hardware resources. Execution of the instructions may update operation of the hardware resources, thereby updating (operation of) data processing system 102A.

For example, if pairing is successful, then data processing system 102A may enter a power state for providing desired computer-implemented services (e.g. a nominal power state, a high-power state). However, if pairing is unsuccessful, then data processing system 102A may enter a waiting state. The waiting state may include a power-off state, and power may not be distributed to hardware resources of data processing system 102A while data processing system 102A is in the power-off state. While in the waiting state, data processing system 102A may attempt to connect to a PDU (e.g., power distribution unit 104, or another PDU) until successful.

When the new power state is enforced on at least hardware resources of data processing system 102A, an updated data processing system may be obtained (e.g., with updated operation of the hardware resources). The updated data processing system (e.g., updated data processing system 102A) may provide a computer-implemented service using the updated hardware resources and power distributed via multi-function connection 105A.

Although not shown in FIG. 2A, power distribution unit 104 may provide power to other connected data processing systems via other power ports of power distribution unit 104 and other distinct multi-function connections. The other power ports of power distribution unit 104 may be operating in different power modes that reflect pairing states and/or policies (e.g., power privileges) of the other connected data processing systems.

Thus, using processes and interactions shown in FIG. 2A, device pairing may be performed using power-based communications. The devices may only be paired if not previously paired with other devices, and/or if approved by a management system that maintains a mapping of the power distribution system. By doing so, the mapping of the power distribution system may be more likely to reflect actual power connections within the deployment, which may improve management of the distribution of power within the deployment.

Turning to FIG. 2B, a second interaction diagram in accordance with an embodiment is shown. The second interaction diagram may illustrate processes and interactions that may occur to validate a power connection (e.g., a device pairing) between a data processing system and a PDU. In the example shown in FIG. 2B, data processing system 102B may include functionality for participating in validation processes, and may be different than data processing system 102A of FIG. 2A. However, in other examples where data processing system 102B does not include native functionality for participating in validation processes, data processing system 102B may include an intermediary device that may participate in the pairing process on behalf of data processing system 102B. Refer to FIG. 1C for more information regarding intermediary devices.

Prior to initialization process 210A, data processing system 102B may be in a power-off state, as indicated by dashed lines descending from the shape representing data processing system 102B. For example, data processing system 102B may not be connected to a source of power (e.g., a PDU of the power distribution system). To provide power to data processing system 102B, a power connection may be established with power distribution unit 104 (e.g., a service technician may plug a power cord connected to power distribution unit 104 into a power receptacle of data processing system 102B), prompting performance of initialization process 210A and/or initialization process 210B.

Initialization process 210B may be similar to initialization process 200B of FIG. 2A. For example, power distribution unit 104 may detect the power connection and start providing power to data processing system 102B via multi-function connection 105A in accordance with policies for the power distribution system (e.g., indicated by the solid line descending from initialization process 210A).

Initialization process 210A may be similar to initialization process 200A of FIG. 2A. For example, data processing system 102B may identify that the power connection has been established with power distribution unit 104 via multi-function connection 105A, and may request information that indicates a pairing state for power distribution unit 104. At interaction 211, data may be exchanged between data processing system 102B and power distribution unit 104 (using methods similar to interaction 201 of FIG. 2A).

For example, data processing system 102B may obtain the requested information indicating the pairing state for power distribution unit 104. In the example shown in FIG. 2B, power distribution unit 104 may be paired with data processing system 102A of FIG. 2A, as described with respect to FIG. 2A. Therefore, during initialization process 210A, data processing system 102B may identify that the pairing state for power distribution unit 104 is paired.

Based on the pairing state for power distribution unit 104, data processing system 102B and/or power distribution unit 104 may participate in validation process 212 to determine whether data processing system 102B and power distribution unit 104 are paired devices. During validation process 212, power distribution unit 104 may attempt to validate credentials stored by data processing system 102B (e.g., via data exchange). However, credentials stored by data processing system 102B may not match credentials stored by power distribution unit 104 by virtue of power distribution unit 104 having agreed upon the credentials with data processing system 102A. Therefore, negotiations between data processing system 102B and power distribution unit 104 may fail, and validation process 212 may be unsuccessful.

Based on an outcome of validation process 212, a notification may be obtained (e.g., generated). For example, the notification may be generated by data processing system 102B and/or power distribution unit 104, and may include (i) identifiers for connected devices (e.g., data processing system 102B, power distribution unit 104), (ii) the outcome of the validation process (e.g., unsuccessful), and/or (iii) other information (e.g., identifiers for the service technician that made the connection, administrators of the devices).

At interaction 213, the notification may be provided to management system 108 by power distribution unit 104 over data connection 280 using methods similar to those discussed with respect to interaction 203 of FIG. 2A. Upon obtaining the notification, management system 108 may distribute an alert indicating an unexpected (e.g., erroneous) power connection within the deployment. For example, the alert may be provided via a service console on another device managed by an administrator of the deployment and/or to a mobile phone in possession of the service technician. By doing so, an entity associated with the deployment, data processing system 102B, and/or power distribution unit 104 may be alerted in real-time, allowing the entity to take steps to correct the erroneous power connection timely.

In some examples, power distribution unit 104 and/or data processing system 102B may include alerting components that may be used to indicate a successful or unsuccessful outcome of validation process 212. For example, power distribution unit 104 may raise an alert such as an audible alert (e.g., playing a sound from a speaker), a visual alert (e.g., displaying a light), a haptic alert (e.g., a vibration, a tap), and/or any combination thereof. By doing so, an entity in the physical environment may be alerted in real-time, and the alert may prompt the entity to correct the erroneous power connection in real-time.

Based on the outcome of validation process 212, power distribution unit 104 may perform power mode update process 218 to enforce a new power mode on the power port facilitating multi-function connection 105A. Power mode update process 218 may be similar to power mode update process 208 of FIG. 2A. For example, policies for the power distribution system may specify that upon unsuccessful validation of a data processing system, power distribution unit 104 is to enter a power-off mode, where no power is provided to data processing system 102B (e.g., as indicated by dashed lines descending from validation process 212).

In response to the unsuccessful outcome of validation process 212 (and/or to the lack of power provided by power distribution unit 104) data processing system 102B may enter a waiting state (e.g., ready to connect to another PDU). For example, data processing system 102B may perform a process similar to power state enforcement process 206 of FIG. 2A to enter the waiting state.

Any of the processes illustrated using the second set of shapes and interactions illustrated using the third set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes and interactions illustrated using the third set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor-based devices (e.g., computer chips).

Any of the processes and interactions may be implemented using any type and number of data structures. The data structures may be implemented using, for example, tables, lists, linked lists, unstructured data, data bases, and/or other types of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

Thus, using processes and interactions shown in FIGS. 2A-2B, power connections between components of a deployment may be validated based on device pairings over existing multi-function connections using power-line communication technology. By doing so, additional types of connections (e.g., network connections) and/or manual auditing processes may not be required to identify and/or manage erroneous power connections within the deployment. As a result, the power connections established within the deployment may be more likely to be consistent with a mapping of the power distribution system used for power budgeting and/or other types of power management services for the deployment.

Turning to FIG. 3, a flow diagram illustrating a method in accordance with an embodiment is shown. The flow diagram may illustrate various operations performed when managing a data processing system.

At operation 300, the data processing system may identify that a PDU is operably connected via a multi-function connection, the multi-function connection being adapted to both supply power to the data processing system and facilitate communication between the data processing system and the PDU. The operable connection may be identified by (i) obtaining a notification indicating that the PDU is operably connected to the data processing system (e.g., from another device via any type of data connection), (ii) detecting a change in electrical characteristics of a power source of the data processing system (e.g., an increase in power supplied to a component of the data processing system), and/or (iii) other methods.

At operation 302, a pairing state for the PDU may be identified by the data processing system. The pairing state may be identified by (i) obtaining a notification indicating the pairing state for the PDU, (ii) requesting pairing information from the PDU (e.g., using the multi-function connection), (iii) obtaining and/or parsing the pairing information, and/or (iv) other methods.

For example, the PDU may store a data structure that includes a flag (e.g., one or more bits that are used to store a binary value or a Boolean variable that indicates whether the PDU is paired or unpaired. The data structure and/or portions thereof (e.g., the bits that store the binary value) may be provided to the data processing system during an initialization process for the data processing system and/or the PDU. Refer to initialization processes 200A and 200B of FIG. 2A or more information.

At operation 304, a determination may be made regarding whether the pairing state for the PDU is paired. For example, if the notification and/or the pairing information indicate that the PDU is not paired (e.g., unpaired), then the method may proceed to operation 310 following operation 304. Otherwise, if the notification and/or the pairing information indicate that the PDU is paired, then the method may proceed to operation 306 following operation 304.

At operation 306, the data processing system may collaboratively enforce a new power state for the data processing system with the PDU to obtain an updated data processing system. The new power state may be collaboratively enforced by methods described with respect to power state enforcement process 206 of FIG. 2A and/or by other methods. For example, collaboratively enforcing the new power state may include obtaining, by the data processing system and from the PDU via the multi-function connection, information indicating the new power state for the data processing system.

The information indicating the new power state for the data processing system may be obtained by (i) reading the information from storage, (ii) receiving the information (e.g., via the PDU), using credentials established when the pairing state for the PDU was changed to paired (e.g., during a pairing process), and/or (iii) generating the information. For example, the information may include characteristics of power warranted for the data processing system (e.g., based on policies for the PDU and/or a power distribution system thereof). The information indicating the new power state may be generated using policies for the data processing system to identify the power state associated with the characteristics of power warranted for the data processing system.

Collaboratively enforcing the new power state may include (i) providing, by the data processing system and via the multi-function connection, identification information usable to establish an identity of the data processing system to the PDU, and (ii) obtaining, by the data processing system and via the multi-function connection, a response from the PDU, the response indicating characteristics of new power that the PDU believes is warranted for the data processing system. The providing and the obtaining may be performed while power is being distributed via the multi-function connection.

For example, the identification information may be to the PDU via the multi-function connection. The identification information may be provided by methods described with respect to pairing process 202 of FIG. 2A and/or by other methods. For example, while power is being distributed via the multi-function connection, a data package including the identification information may be encoded onto a carrier signal distributed via the multi-function connection using an encoding technique that modulates the carrier signal to reflect information in the data package.

The response may be obtained via the multi-function connection. The response may be obtained by methods described with respect to pairing process 202 of FIG. 2A and/or by other methods. For example, while power is being distributed via the multi-function connection, a modulated carrier signal (e.g., modulated to reflect a data package including the response) may be decoded (e.g., by a component of the data processing system) to obtain the response.

Enforcing the new power state may include modifying power consumption by the data processing system. For example, the power state may be enforced by executing instructions to (i) power or depower components of the hardware resources, (ii) power or depower portions of components of the hardware resources, and/or (iii) modify configuration settings of components of the hardware resources that may reduce power consumption by the data processing system. By doing so, operation of the hardware resources may be updated, and an updated data processing system may be obtained.

At operation 308, a computer-implemented service may be provided using the updated data processing system. The computer-implemented service may be provided using the updated data processing system by (i) obtaining instructions for providing the computer-implemented service (e.g., user input, input from another device), (ii) providing the instructions to the hardware resources (e.g., inserting the instructions into an execution flow of a component of the hardware resources), and/or (iii) allowing execution of the instructions by the hardware resources while the hardware resources are operating in the new power state.

The method may end following operation 308.

Returning to operation 304, if the data processing system identifies that the pairing state for the PDU is unpaired, then the method may proceed to operation 310 following operation 304.

At operation 310, at least the data processing system may perform a pairing process to attempt to change the pairing state for the PDU to paired. The pairing process may be performed by the data processing system and/or the PDU by methods described with respect to pairing process 202 of FIG. 2A and/or by other methods. For example, during the pairing process, credentials may be established that enable communications between the data processing system and the PDU to be cryptographically verified.

At operation 312, a determination may be made regarding whether the pairing state is changed to paired. The determination may be made by (i) obtaining an outcome of the pairing process (ii) requesting, obtaining, and/or parsing pairing information from the PDU, and/or (iii) by other methods. For example, if the outcome indicates that the pairing process was successful, (e.g., the pairing status for the PDU has changed to paired) and/or if the pairing information indicates that the pairing state for the PDU is paired, then the method may proceed to operation 306 following operation 312. Otherwise (e.g., if the pairing state has not changed to paired), then the method may proceed to operation 314 following operation 312.

At operation 314, the data processing system may enter a waiting state. The data processing system may enter the waiting state by updating operation of hardware resources of the data processing system. Entering the waiting state may include updating power consumption by the hardware resources by a power manager, a management controller, and/or another component of the data processing system. For example, entering the waiting state may include (i) depowering components of the hardware resources, (ii) depowering portions of components of the hardware resources, and/or (iii) modifying configuration settings of components of the hardware resources that may reduce power consumption by the data processing system.

While in the waiting state, the data processing system may attempt to connect to a second PDU until successful. Therefore, components necessary for attempting to connect to the second PDU may remain powered (e.g., by a battery and/or by other source of power) while other components (and/or portions thereof) may be depowered.

The method may end following operation 314.

Returning to operation 312, if the pairing state for the PDU is changed to paired (e.g., as a result of the pairing process), then the method may proceed to operation 306 following operation 312. Refer to the discussion of operation 306, above.

Thus, as illustrated above, embodiments disclosed herein may provide systems and methods for managing data processing systems of a deployment with respect to power consumption by the data processing systems using power-based communications. By doing so, unexpected power connections (e.g., operably connected but unpaired devices) may be more likely to be identified timely, resulting in improved management of power distribution within the deployment. By leveraging existing multi-function connections that power the data processing systems to do so, additional connectivity and/or manual efforts may not be required to identify the unexpected power connections within the deployment.

Any of the components illustrated in FIGS. 1A-3 may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high-level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random-access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a Wi-Fi transceiver, an infrared transceiver, a Bluetooth transceiver, a WiMAX transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid-state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also, a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs, or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components, or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system’s registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g., circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing a data processing system, the method comprising:
identifying, by the data processing system, that a power distribution unit (PDU) is operably connected via a multi-function connection, the multi-function connection being adapted to both supply power to the data processing system and facilitate communication between the data processing system and the PDU;
identifying, by the data processing system, a pairing state for the PDU; and
in a first instance of the identifying where the pairing state for the PDU is unpaired:
performing, by at least the data processing system, a pairing process to attempt to change the pairing state for the PDU to paired, and
in a first instance of the performing where the pairing state for the PDU is changed to paired:
collaboratively enforcing, by the data processing system and with the PDU, a new power state for the data processing system to obtain an updated data processing system; and
providing, by the updated data processing system, a computer-implemented service.

2. The method of claim 1, wherein collaboratively enforcing the new power state for the data processing system comprises:
obtaining, by the data processing system and from the PDU via the multi-function connection, information indicating the new power state for the data processing system.

3. The method of claim 2, wherein the information is obtained using credentials established when the pairing state for the PDU is changed to paired.

4. The method of claim 3, wherein the credentials enable communications between the data processing system and the PDU to be cryptographically verified.

5. The method of claim 1, further comprising:
in a second instance of the performing where the pairing state for the PDU is not changed to paired:
entering, by the data processing system, a waiting state.

6. The method of claim 5, wherein while in the waiting state, the data processing system attempts to connect to a second PDU until successful.

7. The method of claim 1, further comprising:
in a second instance of the identifying where the pairing state for the PDU is paired:
collaboratively enforcing, by the data processing system and with the PDU, the new power state for the data processing system to obtain the updated data processing system; and
providing, by the updated data processing system, the computer-implemented service.

8. The method of claim 1, wherein collaboratively enforcing the new power state for the data processing system comprises:
providing, by the data processing system and via the multi-function connection, identification information usable to establish an identity of the data processing system to the PDU; and
obtaining, by the data processing system and via the multi-function connection, a response from the PDU, the response indicating characteristics of new power that the PDU believes is warranted for the data processing system.

9. The method of claim 8, wherein the providing of the identification information and the obtaining of the response are performed while power is being distributed via the multi-function connection.

10. The method of claim 1, wherein enforcing the new power state modifies power consumption by the data processing system.

11. The method of claim 1, wherein the PDU is adapted to obtain data center level power and supply power source level power via distinct multi-function connections to at least the processing system.

12. The method of claim 1, wherein the data processing system is connected to the PDU via an out-of-band communication channel that runs through a network module of the data processing system and the out-of-band communication channel services a management controller of the data processing system.

13. The method of claim 12, wherein the data processing system is connected to at least one other entity via an in-band communication channel that also runs through the network module and the in-band communication channel services hardware resources of the data processing system.

14. A non-transitory machine-readable medium having instructions stored therein, which when executed by a processor, cause the processor to perform operations for managing a data processing system, the operations comprising:
identifying, by the data processing system, that a power distribution unit (PDU) is operably connected via a multi-function connection, the multi-function connection being adapted to both supply power to the data processing system and facilitate communication between the data processing system and the PDU;
identifying, by the data processing system, a pairing state for the PDU; and
in a first instance of the identifying where the pairing state for the PDU is unpaired:
performing, by at least the data processing system, a pairing process to attempt to change the pairing state for the PDU to paired, and
in a first instance of the performing where the pairing state for the PDU is changed to paired:
collaboratively enforcing, by the data processing system and with the PDU, a new power state for the data processing system to obtain an updated data processing system; and
providing, by the updated data processing system, a computer-implemented service.

15. The non-transitory machine-readable medium of claim 14, wherein collaboratively enforcing the new power state for the data processing system comprises:
obtaining, by the data processing system and from the PDU via the multi-function connection, information indicating the new power state for the data processing system.

16. The non-transitory machine-readable medium of claim 15, wherein the information is obtained using credentials established when the pairing state for the PDU is changed to paired.

17. The non-transitory machine-readable medium of claim 16, wherein the credentials enable communications between the data processing system and the PDU to be cryptographically verified.

18. A data processing system, comprising:
a processor; and
a memory coupled to the processor to store instructions, which when executed by the processor, cause operations for managing the data processing system to be performed, the operations comprising:
identifying, by the data processing system, that a power distribution unit (PDU) is operably connected via a multi-function connection, the multi-function connection being adapted to both supply power to the data processing system and facilitate communication between the data processing system and the PDU,
identifying, by the data processing system, a pairing state for the PDU, and
in a first instance of the identifying where the pairing state for the PDU is unpaired:
performing, by at least the data processing system, a pairing process to attempt to change the pairing state for the PDU to paired; and
in a first instance of the performing where the pairing state for the PDU is changed to paired:
collaboratively enforcing, by the data processing system and with the PDU, a new power state for the data processing system to obtain an updated data processing system, and
providing, by the updated data processing system, a computer-implemented service.

19. The data processing system of claim 18, wherein collaboratively enforcing the new power state for the data processing system comprises:
obtaining, by the data processing system and from the PDU via the multi-function connection, information indicating the new power state for the data processing system.

20. The data processing system of claim 19, wherein the information is obtained using credentials established when the pairing state for the PDU is changed to paired.
